(19) United States
(12) Patent Application Publication
(10) Pub. No.: US 2010/0315490 A1
(43) Pub. Date: Dec. 16, 2010

(54) APPARATUS AND METHOD FOR GENERATING DEPTH INFORMATION

(75) Inventors: Taeone KIM, Daejeon (KR); Namho HUR, Daejeon (KR); Jin-Woong KIM, Daejeon (KR); Gi-Mun UM, Daejeon (KR); Gun BANG, Daejeon (KR); Eun-Young CHANG, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/689,390

(22) Filed: Jan. 19, 2010

(30) Foreign Application Priority Data
Jun. 15, 2009 (KR) 10-2009-0053018

(51) Int. Cl. H04N 13/02; G06K 9/00

(52) U.S. Cl. 348/47; 382/154; 348/E13.074

(57) ABSTRACT

An apparatus for generating depth information, includes: a projector configured to project a predetermined pattern to an object to be photographed; a left camera configured to acquire a left image of a structured light image which is generated by projecting the predetermined pattern to the object; a right camera configured to acquire a right image of the structured light image; a depth information generating unit configured to determine correspondence points based on the left image, the right image and the structured light pattern, to generate depth information of the image, to determine the depth information by applying a stereo matching method to the left image and the right image when the structured light pattern cannot be applied to a field of the image, and to generate depth information of entire image based on the acquired depth information.

### CROSS-REFERENCE TO RELATED APPLICATIONS

The present invention claims priority of Korean Patent Application No. 10-2009-0053018, filed on Jun. 15, 2009, which is incorporated herein by reference.

### BACKGROUND OF THE INVENTION

1. Field of the Invention

The present invention relates to an apparatus and method for generating depth information for three dimension broadcasting.

2. Description of Related Art

In general, a camera is used to generate an image signal. The camera is divided to one which captures a static image signal and the other which captures a dynamic image signal. Both of the camera capturing the static image signal and the camera capturing the dynamic image signal acquire two dimensions image and provide the image signals.

Due to fast development of technology, a method for acquiring three dimensions image by the camera has been developed and depth information is used as an important element to acquire the three dimensions image. The depth information provides a distance from a point of an object to another point in the acquired two dimensions image. Accordingly, the two dimensions image can be expressed to the three dimensions image based on the depth information.

The depth information is needed to acquire the three dimensions image. The method for acquiring three dimensions image includes a passive method and an active method.

According to the passive method, a plurality of the two dimensions image information are acquired from different angle by using multiple cameras and depth information is detected based on the acquired multiple two dimension image information. That is, according to the passive method, the images of an object are directly acquired, and the depth information is acquired based on the images. In the passive method, any physical intervention is not applied to the object. The passive method is a method that generates three dimensions information based on texture information of the images obtained from the multiple optical cameras in different positions. In the passive method, images are obtained in a natural condition, and the images are analyzed to extract depth information of the object.

According to the passive method for acquiring the depth information using the multiple cameras, there are problems that a measuring point for detecting the depth information cannot be freely set and a position of an object having no texture point such as the surface of a wall is not measured. That is, a probability of failure is high to find a correspondence point in an image field having a repetitive structure and the object having no texture. Accordingly, the passive method has an advantage of acquiring easily an image, but it is difficult to detect the depth information when additional information for detecting easily the depth information does not exist. Also, the passive method is largely affected by a light condition and the texture information, has a large error in a shielding area, and has a disadvantage of long computation time to acquire a dense depth map.

Another method for generating depth information is the active method. According to the active method, after an artificial light or a specifically designed pattern is projected to an object to be photographed, an image is acquired.

That is, the method projects a specifically designed structured light to the object by using a projector, acquires images by using cameras, performs a pattern decoding, and detects automatically a correspondence point between the images and a structured light pattern. After detecting the correspondence point between the images and the structured light pattern, the depth information can be acquired based on the correspondence point.

However, the active method has some disadvantages to be described hereafter. Firstly, an image field where the pattern of the structured light image fails to be decoded appears due to limitation of a Depth of Field (DOF). That is, since the DOF focused by the projector in the structured light image is limited to tens centimeters (cm), the depth information on the image field focused by the projector is only acquired. Accordingly, there is a problem that the depth information on part of the object in the DOF focused by the projector is acquired.

Subsequently, a Field of View (FOV) which is viewed by a camera for generating the depth information corresponds to a part which is commonly viewed by the projector and the camera. Accordingly, the FOV becomes fairly smaller. In other words, since the part which is commonly viewed by the projector and the camera is fairly small when the structured light image generated by projecting the structured light pattern to the object is acquired by the camera, there is a problem that only the depth information on part of the object viewed by the camera can be acquired.

### SUMMARY OF THE INVENTION

An embodiment of the present invention is directed to an apparatus and method for acquiring depth information on an acquired entire image.

Another embodiment of the present invention is directed to a method for acquiring detailed depth information from the acquired image.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided an apparatus for generating depth information, including: a projector configured to project a predetermined pattern to an object to be photographed; a left camera configured to acquire a left image of a structured light image which is generated by projecting the predetermined pattern to the object; a right camera configured to acquire a right image of the structured light image; a depth information generating unit configured to determine correspondence points based on the left image, the right image and the structured light pattern, to generate depth information of the image, to determine the depth information by applying a stereo matching method to the left image and the right image when the structured light pattern cannot be applied to a field of the image, and to generate depth information of an entire image based on the acquired depth information.

In accordance with another aspect of the present invention, there is provided a method for generating depth information, including: projecting a predetermined structured light pattern to an object to be used to photograph; acquiring a left structured light image and a right structured light image from the object to which the predetermined pattern is projected; determining a correspondence point information from the left image, the right image and the structured light pattern, generating the depth information of the image based on the correspondence point information when the structured light pattern can be used, and acquiring the depth information by applying a stereo matching method to the left image and the right image when the structured light pattern is not applied to the image field; and generating the depth information of entire image based on the acquired depth information.

### BRIEF DESCRIPTION OF THE DRAWINGS

FIG. 1 shows an apparatus for generating depth information based on a structured light in accordance with an embodiment of the present invention.

FIG. 2 is a block diagram showing an apparatus for generating depth information based on a structured light in accordance with another embodiment of the present invention.

FIG. 3 is a flow chart illustrating a method for generating depth information in accordance with another embodiment of the present invention.

### DESCRIPTION OF SPECIFIC EMBODIMENTS

Other objects and aspects of the invention will become apparent from the following description of the embodiments with reference to the accompanying drawings, which is set forth hereinafter. The same reference numeral is given to the same element, although the element appears in different drawings. In addition, if further detailed description on the related prior arts is determined to obscure the point of the present invention, the description is omitted. The use of the conditional terms and embodiments presented in the present specification are intended only to make the concept of the present invention understood. However, a different term may by used according to each manufacturing company or research group even if the above term is used for the same purpose.

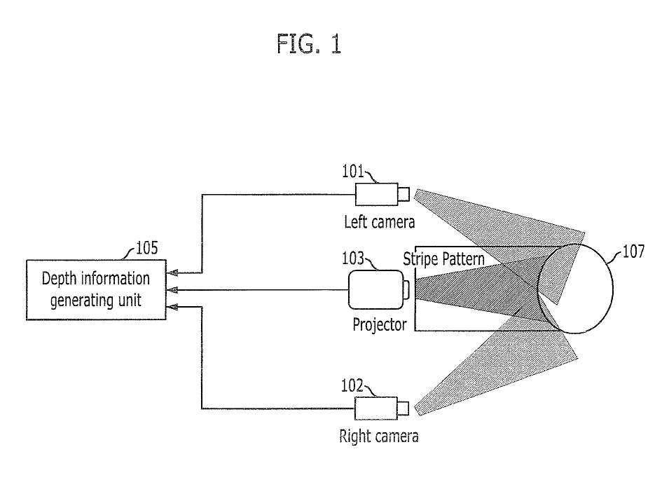

FIG. 1 shows an apparatus for generating depth information based on a structured light in accordance with an embodiment of the present invention.

In the embodiment of the present invention, the apparatus for generating depth information includes a projector 103, a left camera 101, a right camera 102, and a depth information generating unit 105. The projector 103 projects a pattern having predetermined rules to an object 107 to be restored in three dimensions. The predetermined rules include multiple methods such as a pattern arranging stripes each of which color is different to each other, a block stripe boundary pattern, and a sine curve pattern. The specifically designed pattern described above is projected to the object 107.

A left image and a right image are acquired from a structured light image obtained by projecting the structured light pattern to the object through the left camera 101 and the right camera 102. When the left camera 101 and the right camera 102 are used, a structured light pattern of the projector 103 and a Field of View (FOV) in which the left camera 101 and the right camera 102 can commonly view is more broadened than when one camera is used.

Also, the depth information generating unit 105 extracts characteristic points of the left image and the right image by comparing the structured light pattern of the projector 103 with the left image acquired from the left camera 101 and the right image acquired from the right camera 102 respectively. After positions of the characteristic points are extracted and correspondence points are determined, the depth information generating unit 105 calculates the depth information based on calibrated information of the projector 103, the left camera 101 and the right camera 102, and their correspondence points based on a triangulation method. The calibrated information is detailed information such as heights of the left camera 101, the right camera 102 and the projector 103, and an angle of viewing the object 107.

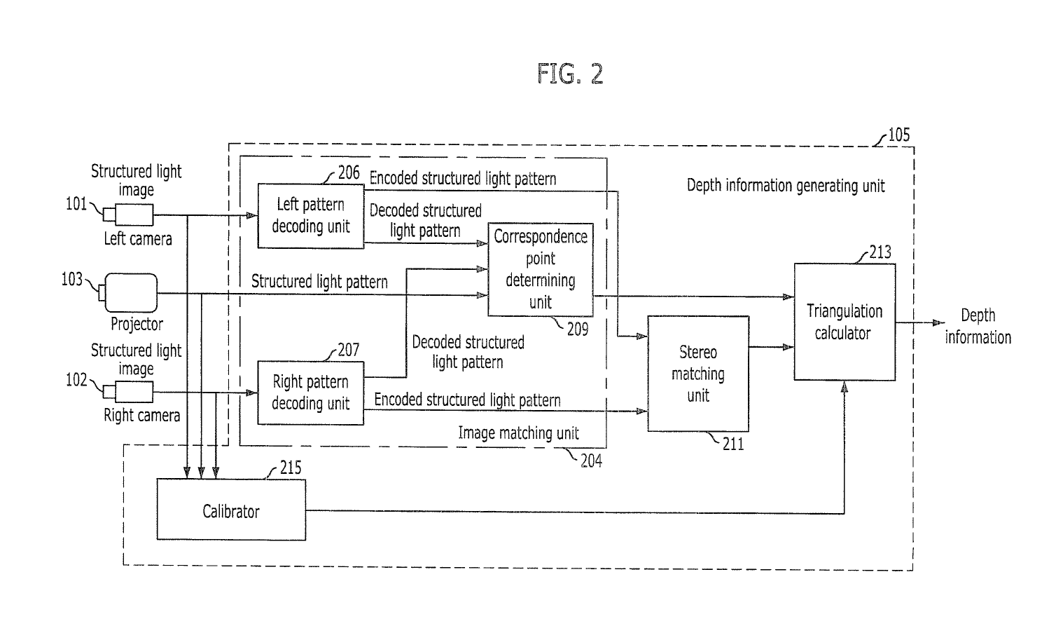

The information generating block 105 will be described in detail with reference to FIG. 2 in accordance with an embodiment of the present invention.

In this embodiment, by using the left camera 101 and the right camera 102, a Field of View (FOV) of the object 107 is broadened more than that when one camera is used. The conventional technology has a problem that the depth information on part of the object 107 located in a Depth of Field (DOF) focused from the projector 103 is acquired, however the above problem can be overcome based on a stereo matching method.

According to the stereo matching method, the left image and the right image of the object 107 are acquired by the left camera 101 and the right camera 102. After the left image and the right image are acquired, correspondence points between the left image and the right image is detected, and the depth information is calculated based on the correspondence points.

That is, the stereo matching method is a method that acquires the image of the object directly and calculates the depth information based on the image, and any physical intervention is not applied to the object. To sum up the stereo matching method, the DOF caused by a small focus of the projector is improved by acquiring an original image and analyzing the acquired image, to thereby calculate the depth information.

Hereafter, a specific embodiment of the present invention will be described in detail with reference to the drawings.

FIG. 2 is a block diagram showing an apparatus for generating depth information based on a structured light in accordance with another embodiment of the present invention.

The apparatus for generating the depth information includes a projector 103, a left camera 101, a right camera 102 and a depth information generating block 105.

The projector 103 projects a pattern having predetermined rules to an object 107 to be restored in three dimensions. A left image and a right image are acquired from a structured light image which is generated by projecting a structured light pattern to the object 105 and obtained by the left camera 101 and the right camera 102.

The acquired left image and right image are inputted along with the structured light pattern of the projector 103 to the depth information generating unit 105 to generate the depth information. The depth information generating unit 105 includes an image matching unit 204, a stereo matching unit 211, a triangulation calculating unit 213, and a calibrating unit 215. The image matching unit 204 includes a left pattern decoding unit 206, a right pattern decoding unit 207 and a correspondence point determining unit 209.

The left pattern decoding unit 206 performs a pattern decoding of the left structured light image acquired through the left camera 101. The pattern decoding means a process to acquire a similarity of a specific point on a predetermined same pattern. For example, the pattern decoding is the process for acquiring the pattern information on the points of the images acquired from the left camera 101 and the right camera 102 based on the structured light pattern.

As mentioned above method, the right pattern decoding unit 207 performs the pattern decoding on the right structured light image acquired through the right camera 102. Structured light image fields pattern-decoded by the left pattern decoding unit 206 and the right pattern decoding unit 207 are referred to as a decoded structured light pattern.

The decoded structured light pattern outputted from the left pattern decoding unit 206 and the right pattern decoding unit 207 is inputted to the correspondence point determining unit 209 to determine a correspondence point relationship.

The correspondence point determining unit 209 determines the correspondence point between the decoded structured light pattern which is pattern-decoded through the left pattern decoding unit 206 and the structured light pattern of the projector 103. Based on the same method as mentioned above method, the correspondence point determining unit 209 determines the correspondence point between the decoded structured light pattern which is pattern-decoded through the right pattern decoding unit 207 and the structured light pattern of the projector 103.

On the contrary, the image which is not pattern-decoded in the left pattern decoding unit 206 and the right pattern decoding unit 207 is called as an undecoded structured light pattern field. The correspondence point relationship cannot be determined through the correspondence point determining unit 209 based on the undecoded structured light pattern. Accordingly, by applying a stereo matching method of the stereo matching unit 211 to the undecoded structured light pattern, the correspondence point information is additionally acquired.

Also, a problem of the conventional technology, a Depth of Field (DOF) caused by using the projector 103 in the apparatus for generating the depth information based on a structured light can be overcome by using the above method. That is, there is a problem that the depth information on only part of the object 107 in the DOF focused by the projector 103 is acquired, however, the above problem is overcome by applying the stereo matching method.

In general, the undecoded structured light pattern field is generated because the structured light image is viewed foggy and blur due to the small DOF of the projector 103 and the pattern decoding fails. However, when the structured light image field which is not pattern-decoded is used as an input of the stereo matching unit 211, the correspondence point may be detected more easily than when a general image is used as input of the stereo matching unit 211, and thus performance of the stereo matching method may be improved.

If the stereo matching method is applied to the undecoded structured light pattern or the correspondence point is determined in the correspondence point determining unit 209, the depth information of the object 107 is generated based on a triangulation of the triangulation calculating unit 213. It is assumed that the left camera 101, the right camera 102 and the projector 103 are calibrated by the calibrating unit 215 in order to use the triangulation. The calibrating unit 215 has detail information such as heights of the left camera 101, the right camera 102 and the projector 103, and an angle of viewing the object 107.

The triangulation calculator 213 generates three dimensions depth information of the object by using the correspondence point between the decoded structured light pattern outputted from the correspondence point determining unit 209 and the structured light pattern of the projector 103 and the information of the calibrator 215 based on the triangulation.

Also, the triangulation calculator 213 may additionally generate the three dimensions depth information of the object by applying the triangulation to a correspondence point value detected in the undecoded structured light pattern field outputted from the stereo matching unit 211 and the information of the calibrator 215.

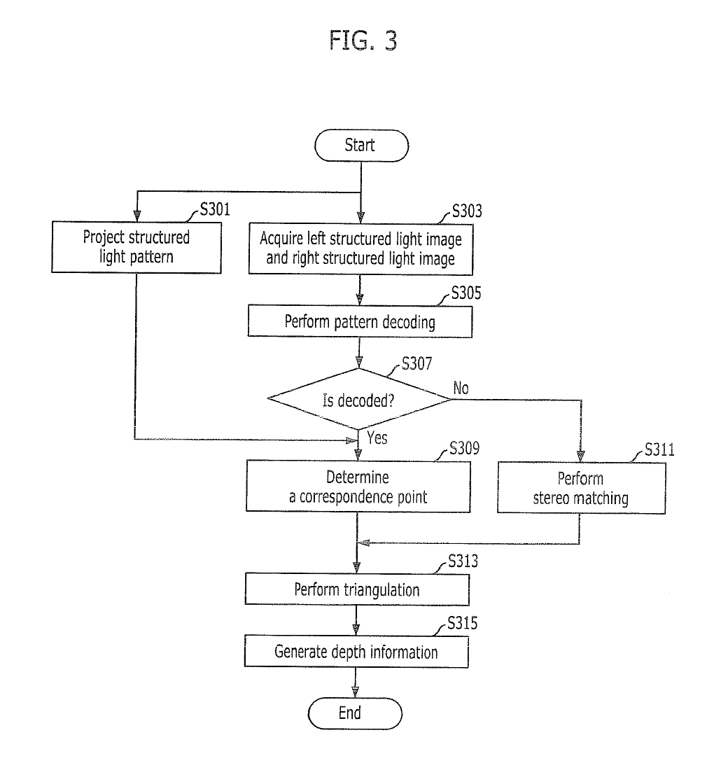

FIG. 3 is a flow chart illustrating a process for generating depth information in accordance with another embodiment of the present invention.

In step S301, the projector 103 projects a structured light pattern, which is specifically designed, to the object 107 to be restored in three dimensions. Herein, in step S303, the left camera 101 and the right camera 102 acquires a left structured light image and a right structured light image that are generated by projecting the structured light pattern of the projector 103 to the object 107. While the projector 103 projects the structured light pattern specifically designed to the object 107 for a predetermined time in the step S301, the left camera 101 and the right camera 102 acquire the left structured light image and the right structured light image from the object 107 to which the structured light pattern is projected. Accordingly, the steps S301 and S303 are shown in parallel in FIG. 3.

In this way, after the left structured light image and the right structured light image are acquired through the left camera 101 and the right camera 102, the left pattern decoding unit 206 performs the pattern decoding on the left structured light image acquired through the left camera 101 and the right pattern decoding unit 207 performs the pattern decoding on the right structured light image acquired through the right camera 102 in step S305.

In step S307, the left pattern decoding unit 206 and the right pattern decoding unit 207 check whether the pattern decoding of the acquired entire images is normally performed. In other words, it is checked whether the pattern decoding of the entire image acquired through the left camera and the right camera is successfully performed based on only the structured light.

If the patter decoding is successfully performed based on only the structured light, the depth information generating unit 105 goes to step S309. Otherwise, the depth information generating unit 105 goes to step S311.

Herein, when the pattern decoding is performed by using only the structured light, the structured light image field which is pattern-coded based on the left pattern decoding unit 206 and the right pattern decoding unit 207 is a decoded structured light pattern and the structured light image field which is not pattern-coded is a undecoded structured light pattern.

The logic flow goes to the step S309 in the case of the decoded structured light pattern. In the step S309, the correspondence point determining unit 209 determines a correspondence point between the decoded structured light pattern obtained by performing the pattern decoding through the left pattern decoding unit 206 and the structured light pattern of the object 130. As mentioned above, the correspondence point determining unit 209 determines the correspondence point between the decoded structured light pattern obtained by performing the pattern decoding through the right pattern decoding unit 207 and the structured light pattern of the object 130.

Otherwise, the logic flow goes to the step S311 in the case of the undecoded structured light pattern. Since the correspondence point relationship is not determined through the correspondence point determining unit 209 based on the undecoded structured light pattern, the correspondence point is obtained by applying a stereo matching method.

In accordance with the stereo matching method, a Depth of Field (DOF) caused by a small focus of the projector 103 is overcome by acquiring and analyzing an original image to extract the depth information.

When the structured light image field which is not pattern-decoded is used as an input of the stereo matching unit 211, the correspondence point can be detected more easily than when a general image is used as input of the stereo matcher 211, and thus performance of the stereo matching method can be improved.

After the correspondence point is determined by applying the stereo matching method or the correspondence point relationship is determined in the correspondence point determining unit 209, the depth information of the object 107 is generated based on a triangulation of the triangulation calculator 213.

In order to use the triangulation, the left camera 101, the right camera 102 and the projector 103 are calibrated by the calibrator 210 and have detail information, e.g., heights of the left camera 101, the right camera 102 and the projector 103, and an angle of viewing the object 107.

The triangulation calculator 213 generates three dimensions depth information of the object by calculating the correspondence point between the decoded structured light pattern outputted from the correspondence point determining unit 209 and the structured light pattern of the projector 103 and the information of the calibrator 215 based on the triangulation.

The triangulation calculator 213 generates three dimensions depth information of the object by calculating the correspondence point which is found in the undecoded structured light pattern and is outputted to the stereo matching unit 215 and information of the calibrator 215 based on the triangulation.

What is claimed is:

1. An apparatus for generating depth information, comprising:
a projector configured to project a predetermined pattern to an object to be photographed;
a left camera configured to acquire a left image of a structured light image which is generated by projecting the predetermined pattern to the object;
a right camera configured to acquire a right image of the structured light image;
a depth information generating unit configured to determine correspondence points based on the left image, the right image and the structured light pattern, to generate depth information of the image, to determine the depth information by applying a stereo matching method to the left image and the right image when the structured light pattern cannot be applied to a field of the image, and to generate depth information of an entire image based on the acquired depth information.

2. The apparatus of claim 1, wherein the depth information generating unit includes:
an image matching unit configured to receive each of the structured light images of the left camera and the right camera, determine the correspondence points from the left image and the right image;
a stereo matching unit configured to determine the correspondence points by applying the stereo matching method to the image when the field of the image which is not determined the correspondence points in the image matching unit; and
a triangulation calculating unit configured to generate the depth information by calculating the correspondence points outputted from the image matching unit and the correspondence point outputted from the stereo matching unit based on a triangulation.

3. The apparatus of claim 2, wherein the depth information generating unit further includes:
a calibrator configured to provide a calibration information corresponding to a spatial position of the projector and the camera.

4. The apparatus of claim 2, wherein the image matching unit includes:
a pattern decoding unit configured to perform a pattern decoding of the structured light images from the left camera and the right camera based on the structured light pattern respectively, to thereby generate decoded structured light patterns; and
a correspondence point determining unit configured to determine the correspondence points between the decoded structured light patterns and the structured light pattern, to thereby find correspondence points.

5. The apparatus of claim 4, the pattern decoding unit includes:
a left pattern decoding unit configured to perform the pattern decoding of the structured light image from the left camera; and
a right pattern decoding unit configured to perform the pattern decoding of the structured light image from the right camera.

6. A method for generating depth information, comprising:
projecting a predetermined structured light pattern to an object to be used to photograph;
acquiring a left structured light image and a right structured light image from the object to which the predetermined pattern is projected;
determining a correspondence point information from the left image, the right image and the structured light pattern, generating the depth information of the image based on the correspondence point information when the structured light pattern can be used, and acquiring the depth information by applying a stereo matching method to the left image and the right image when the structured light pattern is not applied to the image field; and
generating the depth information of entire image based on the acquired depth information.

7. The method of claim 6, wherein said generating the depth information of entire image based on the acquired depth information includes:
determining the correspondence points from the left structured light image and the right structured light image and the structured light pattern;
determining the correspondence points by applying the stereo matching method to the image in the field which does not have the correspondence points from the two images; and
generating the depth information by applying a triangulation method to the correspondence points.

8. The method of claim 7, further including:
calibrating the depth information based on a spatial position of the camera acquiring the structured light image and the projector projecting the structured light pattern when the depth information is generated.

9. The method of claim 6, wherein said determining the correspondence points includes:
performing pattern decoding of the left structured light image and the right structured light image based on the structured light pattern; and
determining the correspondence points between the decoded structured light pattern obtained by performing the pattern decoding process and the structured light pattern.
